(19) United States
(12) Patent Application Publication
(10) Pub. No.: US 2022/0302458 A1
(43) Pub. Date: Sep. 22, 2022

(54) FLEXIBLE ELECTRODE SUBSTRATE INCLUDING POROUS ELECTRODE, AND METHOD FOR MANUFACTURING SAME

(71) Applicant: KOREA INSTITUTE OF ENERGY RESEARCH, Daejeon (KR)

(72) Inventors: Ha Na YOON, Daejeon (KR); Chung Yul YOO, Daejeon (KR); Sang Hyun PARK, Daejeon (KR); Jung Joon YOO, Daejeon (KR); Young A LEE, Daejeon (KR); Jae Hyun JEON, Daegu (KR); Kyu Yeon JANG, Daejeon (KR)

(73) Assignee: KOREA INSTITUTE OF ENERGY RESEARCH, Daejeon (KR)

(21) Appl. No.: 17/634,686

(22) PCT Filed: Aug. 13, 2019
(86) PCT No.: PCT/KR2019/010290

§ 371 Date: Feb. 11, 2022

(30) Foreign Application Priority Data
Aug. 13, 2019 (KR) 10-2019-0098630

(51) Int. Cl. H01M 4/66; H01M 4/133; H01M 4/04; H01M 4/80; H01M 8/0234; H01M 8/0239; H01M 8/0245; H01G 11/24; H01G 11/26; H01G 11/86; H01G 11/32

(52) U.S. Cl. CPC H01M 4/66; H01M 4/133; H01M 4/0416; H01M 4/80; H01M 8/0234; H01M 8/0239; H01M 8/0245; H01M 4/667; H01M 4/663; H01G 11/24; H01G 11/26; H01G 11/86; H01G 11/32; H01M 2220/30; H01M 2004/021

(57) ABSTRACT

Disclosed are a flexible electrode substrate including a porous electrode, a method for manufacturing the flexible electrode substrate, and an energy storage element including the flexible electrode substrate. The flexible electrode substrate can be attached to various objects due to the excellent electrochemical properties and the adhesive properties thereof and thus is very useful. In particular, since the flexible electrode substrate can be used as an electrode of an energy storage element, an energy storage element including the flexible electrode substrate can be attached to various objects and thus can be used as a sticker-type energy storage element. In addition, the flexible electrode substrate can be easily manufactured by transfer method using a difference in adhesive strength and thus allows a simple manufacturing process thereof. Furthermore, electrodes having various patterns can be manufactured with high level of efficiency through simple adjustment of the manufacturing process.

### TECHNICAL FIELD

The present invention relates to a flexible electrode substrate including a porous electrode, a method of manufacturing a flexible electrode substrate, and an energy storage device including the flexible electrode substrate.

### BACKGROUND ART

In the future industry, batteries will be the biggest driving force in the future energy industry ranging from IT devices such as smartphones, tablet devices, laptops, and smart watches to eco-friendly transportation means. As Internet of Things (IoT) products and electric vehicles are commercialized and popularized, supply of batteries will expand more than now, and techniques of high-capacity and high-efficiency batteries are expected to be more important. In addition, in recent years, realization of the 4th industrial revolution era, in which people, objects, and spaces are all interconnected using cutting-edge information and communication technologies such as artificial intelligence (AI), Internet of Things (IoT), big data, mobility, and robots, has become visible, and battery technology is one of the most important technologies that will realize the 4th industrial revolution era. Particularly, since it needs to continuously supply energy to each independent mobile device using batteries in order to enable ‘everything connected to each other’, which is the core of the 4th industrial revolution, the range of battery application is expected to increase significantly more than it is today. Accordingly, the battery technology is expected to be more and more important.

Existing batteries have a formalized shape such as a cylindrical shape, a prismatic shape, a pouch shape or the like, and since there is a limit to integration of energy storage capacity, it is very difficult to apply batteries to ultra-small devices such as wearable devices or micro devices that require high integration. Recently, lithium thin film batteries are actively developed as a next-generation energy conversion device for wearable devices and micro devices, and researches for developing future-type batteries that go beyond the conventional concepts, such as curved batteries, flexible batteries, cable-type batteries, micro-supercapacitors, and the like, are actively under progress. However, existing lithium thin film batteries are thin film type lithium batteries integrated in the form of a thin film with a thickness of micrometers, which have inherent risks due to the nature of containing lithium, and also have a disadvantage of a short cycle life. In addition, an example of the techniques, such as a curved battery, a flexible battery, a cable-type battery, or the like, is disclosed in Patent Document 1 (Korean Patent Publication No. 2016-0090108) or Patent Document 2 (Korea Patent Publication No. 2017-0006280). However, there are problems such as high price, safety, low capacity, low efficiency, and complicated manufacturing process. Therefore, it needs to develop a future-type energy storage device of a new type having high capacity, high efficiency, high safety, long life, design flexibility, and low cost that exceeds the conventional concepts worldwide.

Meanwhile, in order to meet the rapidly increasing demands for wearable electronic devices, a lot of efforts have been devoted to development of light-weight, flexible, stretchable, and high-efficiency microscale energy storage devices. Among them, since micro-supercapacitor (MSC) exhibits high power density, high energy density, stability, and long cycle life, it emerges as a promising alternative for micro-electromechanical systems, distributed sensor networks, on-chip devices, smart electronic devices, nanorobots, and the like. However, in order to be more suitably applied to wearable electronic devices having flexibility and portability, the MSC should have higher capacitance, and the flexibility, elasticity, and reusability should be high. In addition, it should be able to be easily and repeatedly attached to and detached from various common substrates such as glass, paper and plastic.

Therefore, while conducting researches for solving the problems described above, the inventors of the present invention have found that when the electrode of a micro-supercapacitor is manufactured using a flexible substrate, the micro-supercapacitor can be easily attached to and detached from various substrates, and electrochemical performance of the supercapacitor is also excellent, and have completed the present invention.

### DISCLOSURE OF INVENTION

### Technical Problem

The present invention has been devised to solve the problems described above, and an embodiment of the present invention provides a flexible electrode substrate including a porous electrode.

In addition, another embodiment of the present invention provides a method of manufacturing a flexible electrode substrate including a porous electrode.

The technical problems to be solved by the present invention are not limited to the technical problems mentioned above, and other unmentioned technical problems can be clearly understood by those skilled in the art from the following descriptions.

### Technical Solution

To accomplish the above objects, according to one aspect of the present invention,

there is provided a flexible electrode substrate comprising: a flexible substrate; and a patterned porous electrode formed on one surface of the flexible substrate, wherein the flexible substrate is impregnated in pores of the patterned porous electrode.

The flexible substrate may include a compound that is expressed by the chemical formula 1 shown below.

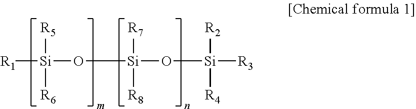

In the chemical formula 1,

R1 to R8 are each independently hydrogen, halogen, hydroxyl group, amino group, straight or branched C1-C10 alkyl, straight or branched C1-C10 alkoxy, straight or branched C1-C10 amino alkyl, straight or branched C2-C10 alkenyl, C3-C20 cycloalkyl, C6-C30 aryl, or C1-C20 alkylcarbonyl, and m and n are each independently an integer between 0 and 100.

The average pore diameter of the porous electrode may be 0.001 to 50 μm.

The porous electrode may include a porous carbon material.

The porous carbon material may include a material selected from a group configured of reduced graphene oxide (rGO), activated carbon, activated carbon fiber, carbon nanotube (CNT), and combinations thereof.

The flexible electrode substrate may further include a coating layer formed on the other surface.

The coating layer may include a material having a functional group selected from a group configured of a catechol group, a galloyl group, a hydroquinone group, an amine group, and combinations thereof.

In addition, in another aspect of the present application,

there is provided an energy storage device comprising the flexible electrode substrate described above as a positive electrode or a negative electrode.

The energy storage device may be a supercapacitor, a secondary battery, or a redox battery.

The width of the porous electrode may be 0.05 to 2 mm.

The distance between the electrodes of the patterned porous electrode may be 0.01 to 1 mm.

The positive electrode and the negative electrode are disposed to face each other, and the energy storage device may further include an electrolyte formed between the positive electrode and the negative electrode.

The electrolyte may include a material selected from a group configured of a solid electrolyte, an aqueous electrolyte, an organic electrolyte, and combinations thereof.

In addition, in still another aspect of the present application,

there is provided a wearable device comprising the energy storage device described above.

In addition, in still another aspect of the present application,

there is provided a method of manufacturing a flexible electrode substrate, the method comprising the steps of: forming a patterned porous electrode on the surface of a temporary substrate; attaching a flexible substrate to the temporary substrate on which the patterned porous electrode is formed, and impregnating the flexible substrate in the pores of the porous electrode; and separating the flexible substrate impregnated in the pores of the porous electrode from the temporary substrate, and moving the patterned porous electrode to the flexible substrate.

The step of forming a patterned porous electrode on the surface of a temporary substrate may be performed using laser irradiation, deposition, or exposure.

Using the laser irradiation may include the steps of: coating a precursor of the porous electrode on the surface of the temporary substrate; and forming a patterned porous electrode on a portion irradiated with a laser by radiating the laser on a portion of the surface of the temporary substrate coated with the precursor of the porous electrode.

The ratio of the thickness of the porous electrode to the thickness of the precursor of the porous electrode may be 1:1 to 10.

Using the deposition may be performed by depositing a porous electrode on the surface of the temporary substrate.

The deposition may be performed using a chemical vapor deposition method, a physical vapor deposition method, or an atomic layer deposition method.

Using the exposure may be performed by exposing the surface of the temporary substrate and etching the surface.

The exposure may be performed using nanoimprint lithography, electron beam lithography, or extreme ultraviolet lithography.

The etching may be dry etching or wet etching.

The step of impregnating the flexible substrate in the pores of the porous electrode may include the steps of applying a flexible substrate precursor on the temporary substrate on which the patterned porous electrode is formed; and curing the applied flexible substrate precursor.

Attachment of the flexible substrate may be attaching the flexible substrate using a semi-cured flexible substrate.

### Advantageous Effects

According to an embodiment of the present invention, the flexible electrode substrate is very useful since it can be attached to various objects as it has excellent electrochemical properties and adhesive properties. Particularly, since the flexible electrode substrate can be used as an electrode of an energy storage device, the energy storage device including the flexible electrode substrate can be attached to various objects, and therefore, it can be used as a sticker-type energy storage device.

In addition, the manufacturing process of the flexible electrode substrate is simple since it can be easily manufactured in a transfer method using a difference in adhesive strength, and it is very efficient since electrodes having various patterns can be manufactured through easy control of the manufacturing process.

It should be understood that the effects of the present invention are not limited to the effects described above, and include all effects that can be inferred from the configuration of the present invention described in the detailed description or claims of the present invention.

### BRIEF DESCRIPTION OF THE DRAWINGS

FIG. 1 is a schematic view showing a flexible electrode substrate according to an embodiment of the present invention.

FIG. 2 is a flowchart illustrating a method of manufacturing a flexible electrode substrate according to an embodiment of the present invention.

FIG. 3 is a schematic view showing a process of manufacturing a flexible electrode substrate according to an embodiment of the present invention.

FIG. 4 is a schematic view showing a manufacturing process and a design view of a micro-supercapacitor according to an embodiment of the present invention.

FIG. 5 is a FE-SEM image showing a highly porous rGO nanosheet formed according to an embodiment of the present invention.

FIG. 6 is an SEM image (FIG. 6a) and a TEM image (FIG. 6b) showing an rGO sheet impregnated in PDMS according to an embodiment of the present invention.

FIG. 7 is a picture showing a sticker-type micro-supercapacitor attached to and detached from goggles according to an embodiment of the present invention.

FIG. 8 is SEM images showing the surface morphology of a micro-supercapacitor electrode before being transferred to a PDMS substrate (FIGS. 8(a) to (c)) and the surface morphology of the micro-supercapacitor electrode after being transferred to a PDMS substrate (FIGS. 8(d) to (f)) according to an embodiment of the present invention.

FIG. 9 shows Raman spectra (FIG. 9a) and XRD patterns (FIG. 9b) of GO and rGO thin films according to an embodiment of the present invention.

FIG. 10 is an FE-SEM image showing a micro-supercapacitor having 20 electrode pins (fsLDW-MSC₂₀, FIG. 10(a)) and a micro-supercapacitor having 40 electrode pins (fsLDW-MSC₄₀, FIG. 10(b)) formed on an SiO₂/Si wafer according to an embodiment of the present invention.

FIG. 11 is an SEM image showing fsLDW-MSC₂₀ (FIG. 11a) and fsLDW-MSC₄₀ (FIG. 11b) transferred to a PDMS substrate according to an embodiment of the present invention.

FIG. 12 is a graph showing the electrochemical properties of fsLDW-MSC₂₀ and fsLDW-MSC₄₀ transferred to a PDMS substrate according to an embodiment of the present invention.

FIGS. 13a and 13b are pictures showing fsLDW-MSC₂₀ transferred to a PDMS substrate before and after bending, respectively, and FIG. 13c is a graph showing the capacity retention rate for 80 bending cycles of fsLDW-MSC₂₀ according to an embodiment of the present invention.

FIGS. 14a and 14b are SEM images showing the surface of fsLDW-MSC₂₀ transferred to a PDMS substrate before bending and after bending 100 times, and FIGS. 14c and 14d are SEM images showing enlarged views of FIGS. 14a and 14b, respectively, according to an embodiment of the present invention.

FIG. 15 is a view showing a micro-supercapacitor (fsLDW-MSC₄₀) having 40 electrode pins transferred to a PDMS substrate, and an XPS irradiation spectrum of a micro-pseudocapacitor (fsLDW-MPC₄₀) having 40 electrode pins coated with dopamine on the surface according to an embodiment of the present invention.

FIG. 16 is a view showing CV curves of fsLDW-MPC₄₀ transferred to a PDMS substrate according to an embodiment of the present invention.

FIG. 17 is a graph showing Cₛₚ according to the scanning rates of fsLDW-MSC₄₀ and fsLDW-MPC₄₀ transferred to a PDMS substrate according to an embodiment of the present invention.

FIG. 18 is a graph showing cycling stability of fsLDW-MSC₄₀ and fsLDW-MPC₄₀ transferred to a PDMS substrate according to an embodiment of the present invention.

FIGS. 19a and 19b are graphs showing adhesive properties of PDMS by thickness according to an embodiment of the present invention.

FIG. 20a is a picture showing a fsLDW-MSC₂₀ array prepared on a 4-inch Si substrate coated with SiO₂ (bottom left) and a sticker-type fsLDW-MSC₂₀ array after being transferred to a PDMS substrate (bottom right) according to an embodiment of the present invention.

FIG. 20b is a picture showing a sticker-type dopamine-coated fsLDW-MPC₂₀ array attached to safety goggles according to an embodiment of the present invention.

FIG. 20c is a graph showing CV curves generated by repeatedly attaching and detaching a sticker-type dopamine-coated fsLDW-MPC₂₀ array on safety goggles according to an embodiment of the present invention.

FIG. 20d is a graph showing capacitance retention during repeated attachment/detachment cycles of a sticker-type dopamine-coated fsLDW-MPC₂₀ array according to an embodiment of the present invention.

FIG. 21 is a view showing pictures of sticker-type fsLDW-MSC and fsLDW-MPC manufactured according to an embodiment of the present invention attached to various objects.

### BEST MODE FOR CARRYING OUT THE INVENTION

Hereinafter, embodiments of the present invention will be described in detail so that those skilled in the art may easily embody the present invention. However, the present invention may be implemented in several different forms and is not limited to the embodiments described herein.

Manufacturing Example. Manufacture of Sticker-Type Micro-Supercapacitor (MSC)

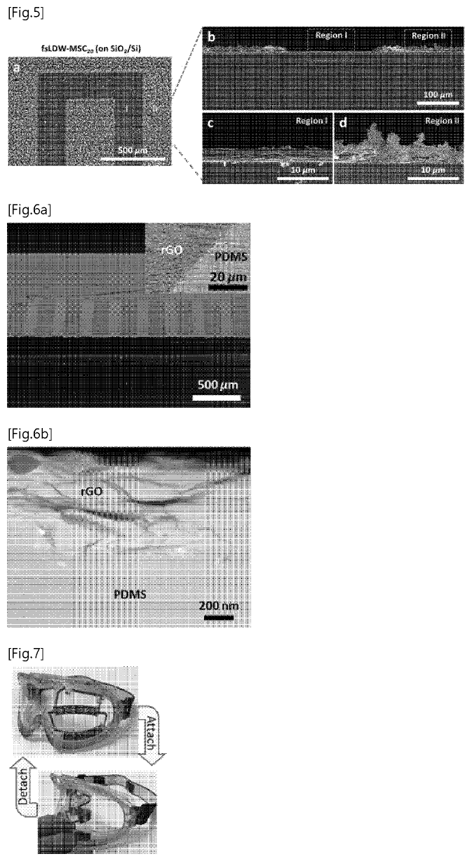

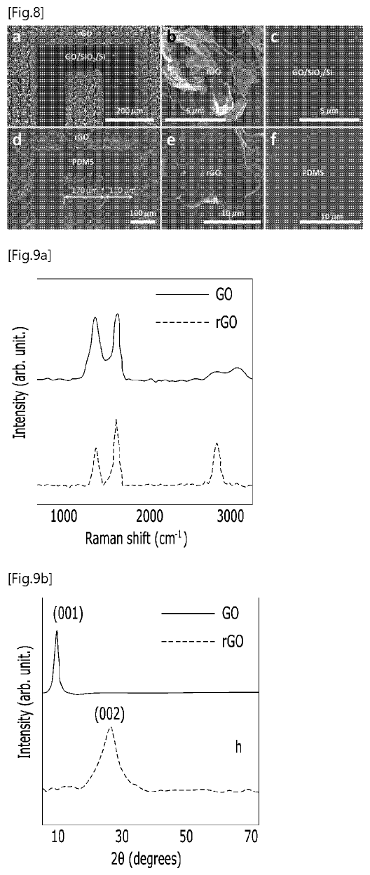

The manufacturing process and design view of a micro-supercapacitor (MSC) using re-attachable femtosecond-laser direct writing (fsLDW) are shown in FIG. 4. The interdigitated rGO electrode of the MSC is patterned by photoreduction of a graphene oxide (GO) thin film through programmed fsLDW (FIGS. 4a and 4b). The basic material of the GO thin film is obtained by dropping GO (2 mg/mL) dispersed in H₂O on a 300 nm-thick Si wafer coated with SiO₂, and then evaporating H₂O. A highly porous rGO nanosheet (FIG. 5) is fabricated using fsLDW having a galvano scanning mirror set that supports a near-infrared (1030 nm) femtosecond pulse laser of high repetition rate (500 kHz) and fast laser beam scanning (125 mm/s). Then, PDMS is poured on the fsLDW-MSC sample, and air is evacuated to completely impregnate the PDMS inside the 3D network of the fsLDW-MSC. After curing by heat treatment for 5 hours at a temperature of 60° C., the MSC/PDMS network working as a flexible sticker-type fsLDW-MSC is separated from the SiO₂/Si wafer (FIG. 4b). The peculiar protruding structure of the rGO sheet induced by fsLDW facilitates efficient transfer of the 3D MSC/PDMS network onto the PDMS without an additional sacrificial layer or treatment (FIGS. 6a and 6b). Owing to the vertically aligned highly porous surface structure of the rGO sheet and the efficient impregnation of the PDMS, the fsLDW-MSC shows an excellent adhesive strength to a flexible substrate (FIGS. 6a and 6b), and a flexible sticker-type fsLDW-MSC₂₀ (an MSC having 20 interdigitated rGO microelectrodes) as shown in FIG. 7 is formed as a result. It is confirmed that the sticker-type fsLDW-MSC has excellent adhesive properties to a temporary substrate, and may be repeatedly attached to and detached from the substrate.

Experiment Example. Analysis of Characteristics of Sticker-Type Micro-Supercapacitor (MSC)

1. Analysis of Surface Morphology

The surface morphology of each patterned MSC electrode is examined by field emission scanning electron microscopy (FE-SEM) before (FIGS. 8(a) to (c)) and after (FIGS. 8(d) to (f)) the MSC is transferred to a PDMS substrate. As shown in FIGS. 8(a) and (b), an rGO sheet is formed by laser irradiation, and the rGO thickness is increased from 2.5 μm or higher to 5.1 μm or higher compared with that of GO (FIG. 5 and FIGS. 8(a) to (c)). FIGS. 9a and 9b show successful formation of an rGO film through fsLDW using Raman spectroscopy and X-ray diffraction (XRD), respectively. The original GO thin film shows Raman D and G bands at 1353 cm⁻¹ and 1589 cm⁻¹, respectively. After the fsLDW, the rGO shows an additional clear 2D peak of 2704 cm⁻¹ in the Raman spectrum. The diffraction peak (001) of the GO initially observed in the XRD pattern having d-spacing of 9.3 Å at 2θ=9.51° disappears, and a new rGO peak (002) with d-spacing of 3.5 Å at 2θ=25.65° is observed.

2. Analysis of Electrochemical Properties

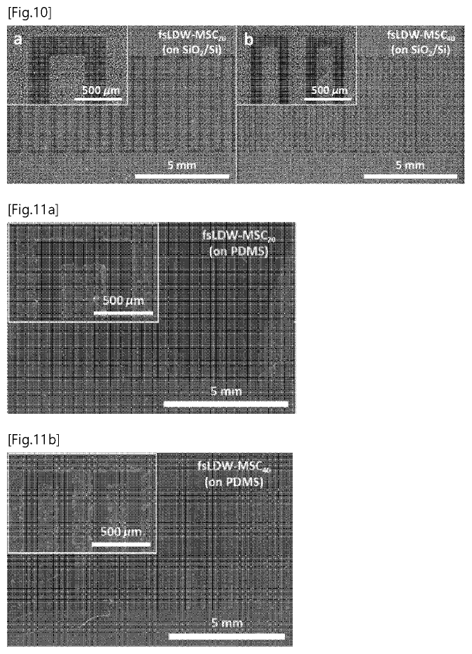

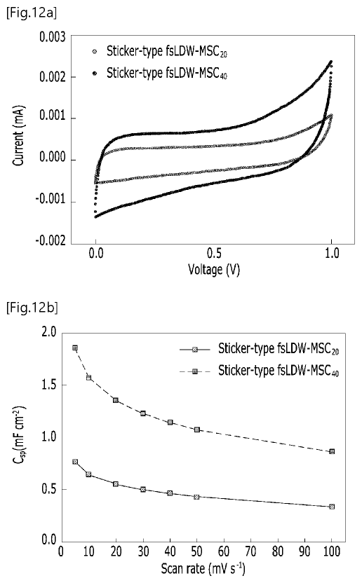

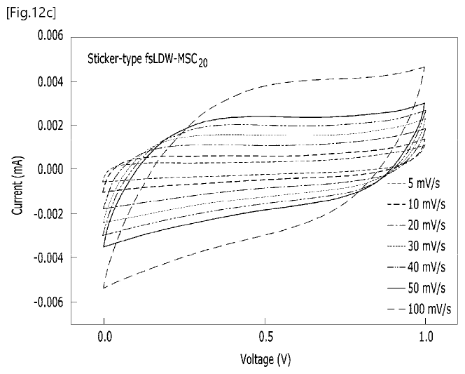

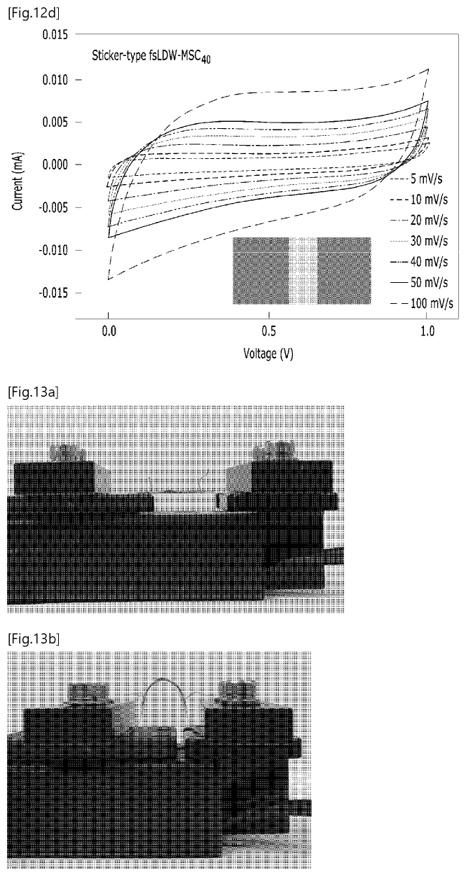

To analyze how the micro-architecture of the MSC affects the electrochemical properties, and MSCs respectively having 20 and 40 interdigitated rGO microelectrodes (hereinafter, referred to as fsLDW-MSC₂₀ and fsLDW-MSC₄₀) are patterned on a SiO₂/Si wafer (FIG. 10) and transferred onto a PDMS film (FIGS. 11a and 11b). The electrochemical properties of the flexible sticker-type fsLDW-MSC₂₀ and fsLDW-MSC₄₀ are tested at a scanning rate of 5 to 100 mV/s (FIG. 12). Poly (vinyl alcohol) and H₂SO₄ hydrogel-polymer electrolytes (PVA-H H₂SO₄) are employed to manufacture all solid state fsLDW-MSCs. Cyclic voltammetry (CV) (FIGS. 12a, 12c and 12d) obtained at 5 to 100 mV/s within the potential range of 0 to 1V shows a quasirectangular shape corresponding to the electric double layer capacitor (EDLC) characteristics. The fsLDW-MSC₄₀ shows a clearly larger CV area, which shows a higher capacitance than the fsLDW-MSC₂₀ at the same scanning rate. FIG. 12b shows a result of calculating the electrode capacitances (Cₛₚ, mF/cm²) per unit area of the fsLDW-MSC₂₀ and fsLDW-MSC₄₀ from the CVs obtained at different scanning rates. The electrode capacitance per unit area of the fsLDW-MSC₂₀ is in a range of 764 to 337 μF/cm² at a scanning rate of 5 to 100 mV/s, whereas the electrode capacitance per unit area of the sticker-type fsLDW-MSC₄₀ is in a range of 1.854 mF/cm² to 861 μF/cm². Recently, it has been shown that, in the case of a thin-film or micro-size secondary battery, the areal and volumetric capacitance may grasp performance of the electrochemical capacitor more accurately compared to the capacitance per unit weight. This is more suitable in the case of the MSC since the mass of the active material is low. Therefore, the inventors of the present invention have calculated the capacitance per unit area of the MSC according to the areas of the device and the electrode. Interestingly, the protruding rGO structure induced by femtosecond pulse laser implements a unique 3D rGO network in PDMS and shows excellent capacitance values with only a thin rGO electrode of sub-micrometers. This is possible owing to the peculiar porous 3D structure of the fsLDW electrode, which is helpful to have a larger specific surface area for ion adsorption on the electrode. In addition, the microscale structure of the device significantly reduces the average ion diffusion length between microelectrode pairs. The effect is shown more predominantly as the number of interdigitated electrodes per unit area increases. Therefore, the sticker-type fsLDW-MSC electrode according to the present invention has a wider surface area that can be used for electrochemical reaction, and shows a higher capacitance and a higher charge/discharge rate compared to those of previously reported microdevices.

On the other hand, in order to evaluate the electrochemical properties according to bending of the MSC, the capacitance according to the bending cycle is measured under the condition of a radius of curvature of 7mm as shown in FIGS. 13a (before bending) and 13b (after bending), and its result is shown in FIG. 13c. At this point, the radius of curvature is calculated by Equation 1 shown below.

$${R}_{bending} = \frac{{L}_{initial}}{2 π \sqrt{\frac{Δ L}{{L}_{initial}} - \frac{{π}^{2} {h}^{2}}{12 {L}_{initial}^{2}}}} \qquad [ Equation 1 ]$$

In Equation 1, R_{bending} is the radius of curvature, Lᵢₙᵢₜᵢₐₗ is the initial length of the flexible electrode substrate, ΔL is the change in length according to bending of the flexible electrode substrate, and h is the thickness of the flexible electrode substrate.

As shown in FIG. 13c, it can be confirmed that the capacity retention rate of the MSC is maintained at about 97% or more during 80 times of bending cycles. It is analyzed that the MSC shows a high-capacity retention rate as described above since the MSC has a structure in which the PDMS is impregnated in the pores of rGO, and as shown in the inset of FIG. 13c, it is confirmed that high electrochemical properties can be maintained since cracks or the like do not occur on the surface of the MSC even after 80 times of bending.

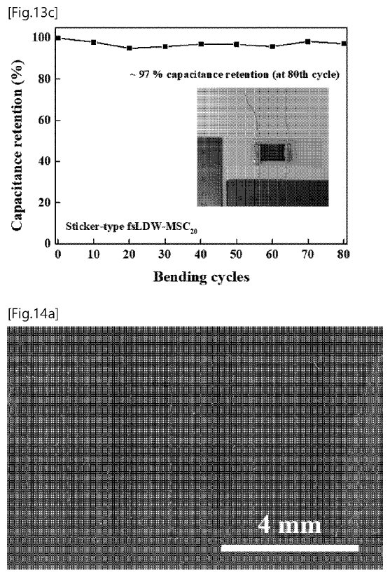

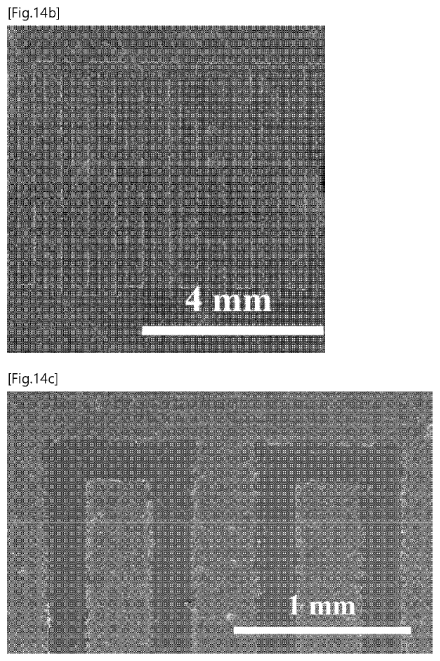

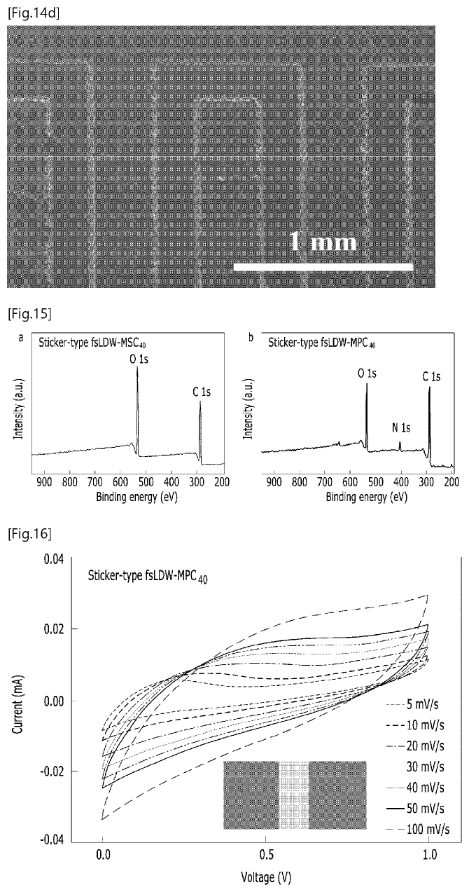

In addition, 100 times of bending is performed in the same manner as described above in order to confirm whether or not cracks occur on the surface of the MSC due to bending, and SEM images of the MSC surface before and after bending 100 times are shown in FIGS. 14a and 14b, respectively. On the other hand, FIGS. 14c and 14d are SEM images showing enlarged views of FIGS. 14a and 14b, respectively. Referring to FIGS. 14a to 14d, it can be confirmed that the MSC does not have a crack on the surface even after 100 times of bending.

3. Analysis of Electrochemical Properties According to Polydopamine Coating

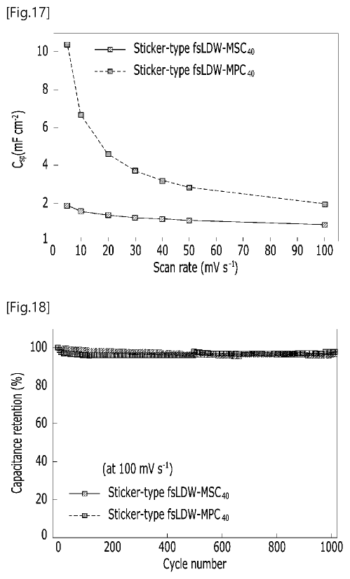

Polydopamine, which is a functional mimic of the adhesive mussel protein (Mytilus edulis foot protein-5 (Mefp-5)), is employed as a coating material for the sticker-type fsLDW-MSC to improve the electrochemical performance. Interest in dopamine as a coating material and adhesion primer is increased recently, and oxidation and self-polymerization of dopamine under alkaline conditions produces polydopamine, and this can be used for coating a large number of inorganic and organic substrates owing to controllable film thickness and high stability. The catechol group of dopamine provides a redox active ingredient to the pseudocapacitor electrode. Consequently, redox active organic molecules attract considerable attention as a promising pseudocapacitor material for energy storage application compared to inorganic materials (such as transition metal oxides and nitrides) and conductive polymers, and this may achieve flexibility of chemical design, as well as potentially higher gravimetric energy density. The redox active organic molecules are inexpensive, eco-friendly, and naturally abundant materials. In addition, the low conductivity and lifetime of the organic molecules can be easily improved by incorporating them into conductive porous carbon materials, and the organic molecules induce pseudocapacitor electrodes having high energy and power density. In order to realize these advantages, a polydopamine layer using a 2 mg/mL dopamine solution (Tris buffer, pH 8.5) is coated on a sticker-type fsLDW-MSC₄₀ sample, and an electrode derived as a result thereof is a sticker-type fsLDW-micro pseudocapacitor (fsLDW-MPC₄₀) As is known, dopamine self-polymerizes into polydopamine through oxidation in a buffer solution. Modification of the fsLDW-MPC₄₀ surface is confirmed by X-ray photoelectron spectroscopy (XPS) (FIG. 15). The uncoated fsLDW-MSCs show C1s and O1s peaks at 284.6 eV and 532.6 eV, respectively. A new N1s peak is observed at 400.6 eV after the polydopamine coating is applied to the fsLDW-MSCs. In order to investigate the effect of dopamine coating on the electrochemical performance of the fsLDW-MPC, CV is obtained at a scanning rate of 5 to 100 mV/s within a range of 0 to 1V potential (FIG. 16). The CV of the sticker-type fsLDW-MPC₄₀ shows a set of broad positive and negative peaks, and this is confirmed to be a pseudocapacitor behavior of the MPC. The insets of FIGS. 12d and 16 show photographic images of the fsLDW-MSC₄₀ and fsLDW-MPC₄₀, respectively. The specific area electrode capacitances (Cₛₚ, F/cm²) (calculated from the CV at different scanning rates) of the fsLDW-MSC₄₀ and fsLDW-MPC₄₀ are shown in FIG. 17, and the Cₛₚ of the fsLDW-MPC₄₀ is in a range of 10.381 to 1.938 mF/cm² in the range of scanning rate of 5 to 100 mV/s. At the same scanning rate of 5 mV/s, the Cₛₚ of the fsLDW-MPC₄₀ (10.381 mF/cm²) is about 6 times higher than the Cₛₚ of the original fsLDW-MSC₄₀ (1.854 mF/cm²). The lifetime stability of the fsLDW-MSC₄₀ and the fsLDW-MPC₄₀ has been studied by cyclic voltammetry at 100 mV/s during 1000 cycles (FIG. 18). The sticker-type fsLDW-MSC 40 and fsLDW-MPC 40 maintain a capacitance of 98% or higher even after 1000 cycles.

4. Analysis of Adhesive Properties of Flexible Substrate

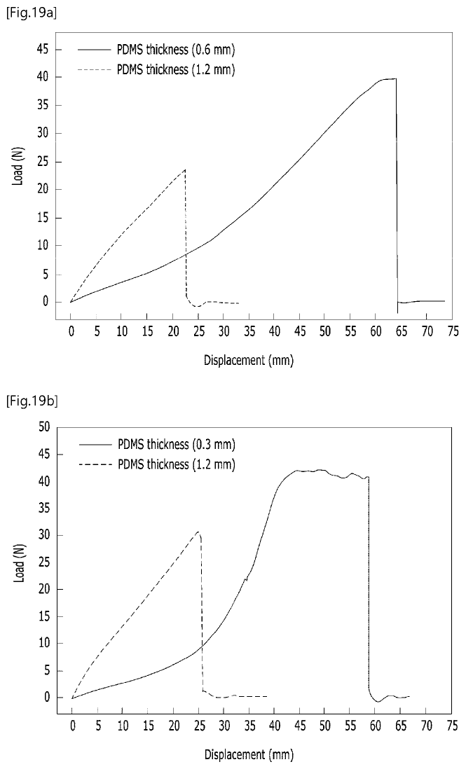

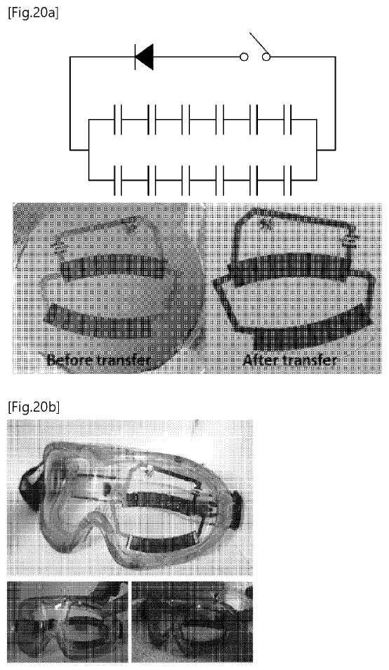

In order to analyze the adhesive properties of the flexible substrate, the adhesive properties according to the thickness of PDMS are measured through a lap shear strength test. First, after fixing PDMS having a thickness of 0.6 mm and 1.2 mm between two glass plates arranged up and down, respectively, the adhesion force (N) according to the displacement (mm) of the PDMS flexible substrate is measured while pulling the upper glass plate connected to a tensile tester, and its result is shown in FIG. 19a. Seeing the result, when the thickness of the PDMS is 1.2 mm, it can be confirmed that the glass plate and the PDMS flexible substrate are separated after the displacement is measured as about 25 mm, and the maximum adhesion force measured at this point is about 25N. On the contrary, when the thickness of the PDMS is 0.6 mm, it can be confirmed that the glass plate and the PDMS flexible substrate are separated after the displacement is measured as about 65 mm, and the maximum adhesion force measured at this point is about 40N. Therefore, it can be confirmed that the thinner the PDMS, the better the adhesive properties.

In addition, in order to measure the adhesive properties for a PDMS having a thickness of 0.3 mm, a tensile tester is arranged at an upper position, and a glass plate is arranged at a lower position, and after fixing PDMS having a thickness of 0.3 mm and 1.2 mm therebetween, respectively, the adhesion force (N) of the PDMS attached to the glass plate according to the displacement (mm) is measured while pulling the tensile tester arranged at the upper position, and its result is shown in FIG. 19b. Seeing the result, when the thickness of the PDMS is 1.2 mm, it can be confirmed that the PDMS is separated from the glass plate after the displacement is measured as about 25 mm, and the maximum adhesion force measured at this point is about 30N. On the contrary, when the thickness of the PDMS is 0.3 mm, it can be confirmed that the PDMS flexible substrate is separated from the glass plate after the displacement is measured as about 60 mm, and the maximum adhesion force measured at this point is about 42N. Therefore, it can be confirmed that the thinner the PDMS, the better the adhesive properties, like the result of the first experiment.

5. Analysis of Applicability

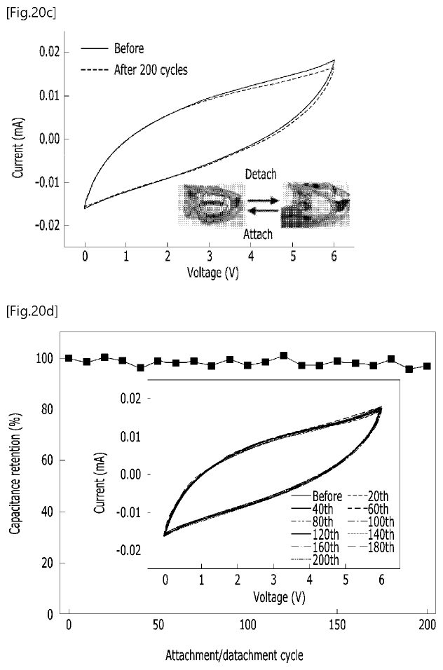

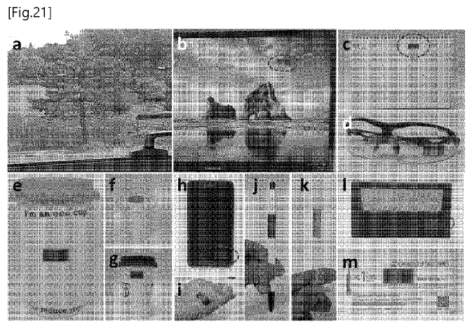

The total energy that can be stored in a single MSC element is not sufficient for general applications. Accordingly, in order to form a specific voltage and a capacitance rating, MSCs should be connected in series and/or parallel, and additional electrical wiring is required. Two advantages of MSC fabrication through laser direct writing are design flexibility and large-area scalability. In order to prove the advantages using the design concept related to an energy storage device for smart glasses, a sticker-type fsLDW-MPC₂₀ array (6 series×2 parallel) is manufactured and attached to a pair of safety goggles as shown in FIG. 20. FIG. 20a shows an fsLDW-MSC₂₀ array manufactured on a 4-inch Si substrate coated with SiO₂ (bottom left) and a sticker-type fsLDW-MSC₂₀ array after being transferred to PDMS (bottom right). The upper image of FIG. 20a shows a schematic equivalent circuit of the sticker-type fsLDW-MSC 20 array. FIG. 20b shows a sticker-type dopamine-coated fsLDW-MPC₂₀ array attached to safety goggles, and this may activate or deactivate a μ-LED (attached to the NTU logo) by touching (a conductive material is placed on the fingertip) a switch (KIER logo). The lower-left and lower-right images in FIG. 20b clearly show stable operation of the red μ-LED driven by the MPC array attached to the safety goggles under bright and dark conditions, respectively. CV curves are recorded while repeatedly attaching and detaching the sticker-type fsLDW-MPC₂₀ array to the safety goggles (FIG. 20c). FIG. 20d shows capacitance retention during repeated attachment/detachment cycles of the fsLDW-MPC₂₀ array. The CV curves show that 97% or more of the original capacitance is maintained during 200 cycles at a scanning rate of 1 V/s as shown in the inset of FIG. 20d. The fsLDW-MSC and the fsLDW-MPC are simply attached to various objects, and the inventors of the present invention attach the MPCs to a window, an LCD monitor, a tumbler, a mobile phone, a pen, and a business card as shown in FIG. 21. The above results show that the sticker-type fsLDW-MSC and fsLDW-MPC have high applicability since they can be easily attached to any substrate without performance degradation during repeated attachment/detachment cycles.

### MODE FOR CARRYING OUT THE INVENTION

Hereinafter, the present invention will be described in more detail. However, the present invention may be implemented in various different forms, and is not limited by the embodiments described herein, and is only defined by the claims described below.

In addition, the terms used in the present invention are only used to describe specific embodiments, and are not intended to limit the present invention. Singular expressions include plural expressions unless the context clearly dictates otherwise. In the entire specification of the present invention, ‘including’ a certain element means that other elements may be further included, rather than excluding other elements, unless otherwise stated.

In a first aspect of the present application,

there is provided a flexible electrode substrate 101 including a flexible substrate 110; and a patterned porous electrode 200 formed on one surface of the flexible substrate 110, wherein the flexible substrate 110 is impregnated in the pores of the patterned porous electrode 200.

Hereinafter, the flexible electrode substrate 101 including the porous electrode 200 according to the first aspect of the present application will be described in detail with reference to FIG. 1. FIG. 1 is a view schematically showing the flexible electrode substrate 101.

In one embodiment of the present application, the flexible electrode substrate 101 may include a flexible substrate 110, and the flexible substrate 110 may include a compound that is expressed by the chemical formula 1 shown below.

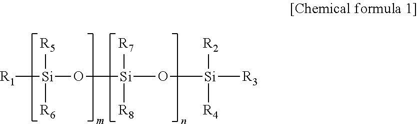

In the chemical formula 1,

R1 to R8 are each independently hydrogen, halogen, hydroxyl group, amino group, straight or branched C1-C10 alkyl, straight or branched C1-C10 alkoxy, straight or branched C1-C10 amino alkyl, straight or branched C2-C10 alkenyl, C3-C20 cycloalkyl, C6-C30 aryl, or C1-C20 alkylcarbonyl, and m and n are each independently an integer between 0 and 100.

Preferably, R1 to R8 are each independently hydrogen, straight or branched C1-C10 alkyl, straight or branched C1-C10 alkoxy, or straight or branched C2-C10 alkenyl, and m and n are each independently an integer between 0 and 100.

Further preferably, R1 to R8 are each independently hydrogen, straight or branched C1-C4 alkyl, straight or branched C1-C4 alkoxy, or straight or branched C2-C4 alkenyl, and m and n are each independently an integer between 0 and 100.

In one embodiment of the present application, although the material expressed by chemical formula 1 may include a repeating unit of Si—O, and preferably may be polydimethyl siloxane (PDMS), Ecoflex, or a mixture of them, it is not limited thereto, and any material having adhesive properties may be used as the flexible substrate 110.

In one embodiment of the present application, the adhesive strength of the flexible substrate 110 may be obtained by measuring lap shear strength, and the lap shear strength may be measured, for example, by the displacement (mm) generated by pulling the tensile tester disposed at the upper position and the adhesion force (N) between the flexible substrate and the glass plate, after fixing the flexible substrate 110 between two glass plates arranged up and down or between the tensile tester and one glass plate arranged up and down. At this point, a preferred thickness range of the flexible substrate 110 measured according to the lap shear strength may be 0.05 to 1.2 mm, further preferably 0.2 to 1.2 mm, and further more preferably 0.3 to 1.2 mm. When the thickness of the flexible substrate 110 is smaller than 0.05 mm, it is too thin, and damage such as tearing of the flexible substrate 110 may occur, and when the thickness exceeds 1.2 mm, it is too thick, and the adhesive strength of the flexible substrate 110 may be lowered. In addition, describing a result of a specific example with respect to the lap shear strength according to the thickness of the flexible substrate 110, when the thickness of the flexible substrate 110 is 0.3 mm, the displacement may be about 60 mm, and at this point, the maximum adhesion force of the flexible substrate attached to the glass plate may be about 42N. In addition, when the thickness of the flexible substrate 110 is 0.6 mm, the displacement may be about 65 mm, and at this point, the maximum adhesion force of the flexible substrate attached to the glass plate may be about 40N. In addition, when the thickness of the flexible substrate 110 is 1.2 mm, the displacement may be about 25 mm, and at this point, the maximum adhesion force of the flexible substrate attached to the glass plate may be about 20 to 30N. That is, the thinner the flexible substrate 110, the better the adhesive properties may be, and this may be determined as the magnitude of the adhesion force in the adhesion force-displacement curve, but it is limited thereto, and should be determined in consideration of various factors such as applied force and the like.

In one embodiment of the present application, the flexible electrode substrate 101 may include a patterned porous electrode 200, and the average pore diameter of the porous electrode 200 may be 0.001 to 50 μm, preferably, 0.01 to 20 μm. When the average pore diameter of the porous electrode 200 is smaller than 0.001 μm, the flexible substrate 110 may not be impregnated in the pores of the porous electrode 200, and when the average pore diameter of the porous electrode 200 exceeds 50 μm, the volume of the electrode itself is too small while porosity of the pores is relatively too high, so that performance as an electrode may be lowered. The average pore diameter of the porous electrode 200 may be adjusted and applied according to the type and size of an applied device, and for example, when it is applied to the electrode of a micro-supercapacitor, the porous electrode 200 may further preferably have an average pore diameter of 0.01 to 5 μm.

On the other hand, the material of the porous electrode 200 may be a carbon material, and the carbon material may include a material selected from a group configured of reduced graphene oxide (rGO), activated carbon, activated carbon fiber, carbon nanotube (CNT), and combinations thereof. On the other hand, the material of the porous electrode 200 is not limited only to the carbon material, and additionally, a composite material of a metal oxide and the carbon material, a composite material of a two-dimensional material and the carbon material, or the like may be used. At this point, the metal oxide may include a material selected from a group configured of, for example, MnO₂, Mn₂O₃, Mn₃O₄, RuO₂, CoO, Co₂O₃, Co₃O₄, WO₃, SnO₂, NiO, IrO₂, RuO₂, V₂O₅, MoO₃, and combinations thereof, and the two-dimensional material may include a material selected from a group configured of, for example, MoS₂, MoSe₂, MoTe₂, TiS₂, TiSe₂, TiTe₂, WS₂, WSe₂, WTe₂, and combinations thereof.

In one embodiment of the present application, the flexible electrode substrate 101 may be characterized in that the flexible substrate 110 is impregnated in the pores of the patterned porous electrode 200. That is, referring to FIG. 1, the patterned porous electrode 200 does not have a specific shape, but may be formed in a three-dimensional random network shape, which is a free shape. Therefore, the pores in the porous electrode 200 may also be formed in a free shape, and the flexible substrate 110 may be impregnated in the pores formed in the side surface portion of the porous electrode 200 or may be impregnated in the pores formed inside thereof. That is, the porous electrode 200 is in the shape of a three-dimensional random network having a plurality of pores and may form networks connected to each other, and more specifically, the porous electrode 200 may be in any shape having a non-uniform orientation or a uniform orientation, such as a card clothing shape with a non-uniform orientation, an oblique shape with a uniform orientation, a shape repeating an X-shaped oblique shape, or the like. On the other hand, since the flexible electrode substrate 101 has a shape in which the flexible substrate 110 is impregnated in the pores of the patterned porous electrode 200, although the flexible substrate 110 is bent, the porous electrode 200 formed on one surface of the flexible substrate 110 may be stably bent together, and problems such as generating cracks may not occur. That is, when the electrode is simply deposited on one surface of the flexible substrate 110, a problem of generating cracks in the electrode or separating the electrode from the flexible substrate 110 may occur when the flexible substrate 110 is bent. However, in the present invention, since the flexible substrate 110 is impregnated in the pores of the porous electrode 200, the above problems may not occur. This may be connected to the electrochemical properties of the flexible electrode substrate 101, and for example, although the flexible electrode substrate 101 is bent tens or hundreds of times, the electrochemical properties of the flexible electrode substrate 101 may be maintained. At this point, the degree of bending may be expressed as a radius of curvature, and the radius of curvature may be calculated by Equation 1 shown below.

$${R}_{bending} = \frac{{L}_{initial}}{2 π \sqrt{\frac{Δ L}{{L}_{initial}} - \frac{{π}^{2} {h}^{2}}{12 {L}_{initial}^{2}}}} \qquad [ Equation 1 ]$$

In Equation 1, R_{bending} is the radius of curvature, Lᵢₙᵢₜᵢₐₗ is the initial length of the flexible electrode substrate, ΔL is the change in length according to bending of the flexible electrode substrate, and h is the thickness of the flexible electrode substrate.

Meanwhile, the flexible electrode substrate 101 may be used as a positive electrode or a negative electrode of an energy storage device, and the energy storage device may be, for example, a supercapacitor, a secondary battery, or a redox battery, preferably, a pseudocapacitor or a micro-supercapacitor among the supercapacitors. In this case, the electrochemical properties may be, for example, capacitance, and although the pseudocapacitor or the micro-supercapacitor including the flexible electrode substrate 101 as an electrode is bent tens or hundreds of times, capacitance of the pseudocapacitor or the micro-supercapacitor may be maintained. Preferably, capacitance of the pseudocapacitor or the micro-supercapacitor may maintain a capacitance of 97% or more compared to the initial capacity even after bending tens or hundreds of times, and further preferably, a capacitance of 99% or more is maintained compared to the initial capacity.

In one embodiment of the present application, the ratio of the thickness of the porous electrode 200 to the thickness of the flexible substrate 110 may be 1:0.0002 to 0.5. When the ratio of the thickness of the porous electrode 200 to the thickness of the flexible substrate 110 is lower than 0.0002, the porous electrode 200 may be too thin to exhibit performance as an electrode, and when the ratio is greater than 0.5, the porous electrode 200 may be too thick, so that the adhesive strength peculiar to the flexible substrate 110 may be lowered. On the other hand, the patterned porous electrode 200 may be one that is patterned in an interdigitated shape. In this case, the width of the porous electrode 200 may be 0.05 to 2 mm, and the distance between the electrodes of the patterned porous electrode 200 may be 0.01 to 1 mm. When the width of the porous electrode 200 and the distance between the electrodes of the patterned porous electrode 200 are out of the ranges, the electrochemical performance of the flexible electrode substrate including the same may be lowered.

In one embodiment of the present application, the flexible electrode substrate 101 may further include a coating layer formed on the other surface, and the coating layer may include a material having a functional group selected from a group configured of a catechol group, a galloyl group, a hydroquinone group, an amine group, and combinations thereof, and preferably, the coating layer may include dopamine or tannic acid. The flexible electrode substrate 101 may have a characteristic of generating redox more smoothly due to the coating layer formed on the other surface, and therefore, the energy storage device including the flexible electrode substrate 101 as an electrode may have excellent electrochemical properties.

In one embodiment of the present application, there may be a plurality of coating layers formed on the other surface of the flexible electrode substrate 101, and for example, when there are two coating layers, the flexible electrode substrate 101 may have a first coating layer formed on the other surface, and a second coating layer formed on the first coating layer. At this point, the first coating layer and the second coating layer may include a functional group selected from a group configured of a catechol group, a galloyl group, a hydroquinone group, an amine group, and combinations thereof on each of the surfaces, and the first coating layer and the second coating layer may be connected to each other by the ions that are coordination-bonded to each of the functional groups. Meanwhile, preferably, the ions may be Fe ions, but are not limited thereto, and all ions capable of coordinating with the functional groups may be used. In addition, when there are three or more coating layers, each coating layer may be deposited in the same manner as described above, and this is implemented in a layer-by-layer (LDL) deposition method using strong interactions between the functional groups and the ions.

In a second aspect of the present application,

there is provided an energy storage device comprising a positive electrode or a negative electrode, and a wearable device comprising the same, and the positive electrode or the negative electrode includes a flexible substrate; and a patterned porous electrode formed on one surface of the flexible substrate, wherein the flexible substrate is impregnated in the pores of the patterned porous electrode.

Although detailed descriptions of the parts overlapping with the first aspect of the present application are omitted, the contents described with respect to the first aspect of the present application may be equally applied even when the description thereof is omitted in the second aspect.

Hereinafter, an energy storage device according to the second aspect of the present application and a wearable device including the same will be described in detail.

In one embodiment of the present application, the energy storage device may be a supercapacitor, a secondary battery, or a redox battery, preferably a supercapacitor, and further preferably a pseudocapacitor or a micro-supercapacitor. In this case, the positive electrode and/or the negative electrode of the supercapacitor may include a flexible substrate and a patterned porous electrode formed on one surface of the flexible substrate. At this point, the flexible substrate may be impregnated in the pores of the patterned porous electrode.

In one embodiment of the present application, the energy storage device may be preferably a micro-supercapacitor, and in this case, the ratio of the thickness of the porous electrode to the thickness of the flexible substrate may be 1:0.0002 to 0.5. When the ratio of the thickness of the porous electrode to the thickness of the flexible substrate is lower than 0.0002, the porous electrode may be too thin to exhibit performance as an electrode, and when the ratio is greater than 0.5, the porous electrode may be too thick, so that the adhesive strength peculiar to the flexible substrate may be lowered. On the other hand, the patterned porous electrode may be one that is patterned in an interdigitated shape. In this case, the width of the porous electrode may be 0.05 to 2 mm, and the distance between the electrodes of the patterned porous electrode may be 0.01 to 1 mm. When the width of the porous electrode and the distance between the electrodes of the patterned porous electrode are out of the ranges, the electrochemical performance of the energy storage device including the same may be lowered. On the other hand, the patterned porous electrode is not limited only to the interdigitated pattern, and any porous electrode of a separate form may be applied.

In one embodiment of the present application, the flexible substrate may include a compound that is expressed by the chemical formula 1 shown below.

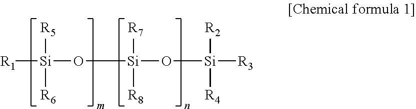

In the chemical formula 1,

R1 to R8 are each independently hydrogen, halogen, hydroxyl group, amino group, straight or branched C1-C10 alkyl, straight or branched C1-C10 alkoxy, straight or branched C1-C10 amino alkyl, straight or branched C2-C10 alkenyl, C3-C20 cycloalkyl, C6-C30 aryl, or C1-C20 alkylcarbonyl, and m and n are each independently an integer between 0 and 100.

In one embodiment of the present application, although the material expressed by chemical formula 1 may include a repeating unit of Si—O, and preferably may be polydimethyl siloxane (PDMS), Ecoflex, or a mixture of them, it is not limited thereto, and any material having adhesive properties may be used as the flexible substrate. Accordingly, since the energy storage device includes the flexible substrate having an adhesive property as an electrode, it may be freely attached to and detached from a desired object.

In one embodiment of the present application, the positive electrode and/or the negative electrode may further include a coating layer formed on the other surface of the flexible substrate, and the coating layer may include a material having a functional group selected from a group configured of a catechol group, a galloyl group, a hydroquinone group, an amine group, and combinations thereof, and preferably, the coating layer may include dopamine or tannic acid. The positive electrode and/or the negative electrode may have a characteristic of generating redox more smoothly due to the coating layer formed on the other surface of the flexible substrate, and therefore, the energy storage device including the positive electrode and/or the negative electrode may have improved electrochemical properties.

In one embodiment of the present application, there may be a plurality of coating layers formed on the other surface of the flexible substrate, and for example, when there are two coating layers, the flexible substrate may have a first coating layer formed on the other surface, and a second coating layer formed on the first coating layer. At this point, the first coating layer and the second coating layer may include a functional group selected from a group configured of a catechol group, a galloyl group, a hydroquinone group, an amine group, and combinations thereof on each of the surfaces, and the first coating layer and the second coating layer may be connected to each other by the ions that have coordinate bonds with the each of the functional groups. Meanwhile, preferably, the ions may be Fe ions, but are not limited thereto, and all ions capable of coordinating with the functional groups may be used. In addition, when there are three or more coating layers, each coating layer may be deposited in the same manner as described above, and this is implemented in a layer-by-layer (LDL) deposition method using strong interactions between the functional groups and the ions.

In one embodiment of the present application, when the energy storage device is a pseudocapacitor, the positive electrode and the negative electrode are disposed to face each other, and the energy storage device may further include a separation membrane formed between the positive electrode and the negative electrode, and an electrolyte. At this point, the material of the separation membrane is not particularly limited, but preferably may be a porous separation membrane that allows ions to pass through, and the electrolyte may include a material selected from a group configured of a solid electrolyte, an aqueous electrolyte, an organic electrolyte, and combinations thereof. That is, the electrolyte may include a material selected from a group configured of, for example, KOH, H₂SO₄, HCl, Li₂SO₄, NaOH, Na₂SO₄, 1-ethyl-3-methylimidazolium tetrafluoroborate (EMIMBF₄), tetraethylammonium tetrafluoroborate (TEABF₄), 1-ethyl-3-methylimidazolium bis (trifluoromethylsulfonyl) imide [EMITFSI], and combinations thereof, or may include a gel-type solid electrolyte prepared by adding a polymer, such as poly (vinyl alcohol) (PVA), poly (vinylidene fluoride) (PVDF), poly (vinylidene fluoride-co-hexafluoropropylene), P (VDF-co-HFP)) or the like, to a liquid electrolyte such as the aqueous electrolyte or the organic electrolyte.

In one embodiment of the present application, when the energy storage device is a micro-supercapacitor, the positive electrode and the negative electrode are disposed to face each other, and the energy storage device may further include an electrolyte formed between the positive electrode and the negative electrode. At this point, the positive electrode and the negative electrode are separated from each other, and may be preferably arranged in an interdigitated shape. That is, since the micro-supercapacitor has a pattern in which the positive electrode and the negative electrode are separated from each other, a separate separation membrane may not be required, and an electrolyte may be included between the positive electrode and the negative electrode. The electrolyte may include a material selected from a group configured of a solid electrolyte, an aqueous electrolyte, an organic electrolyte, and combinations thereof, and specific examples thereof are the same as those described for the pseudocapacitor, and thus detailed description thereof will be omitted. On the other hand, the micro-supercapacitor may be used by connecting in series or parallel according to a required operating voltage or durability.

In one embodiment of the present application, the energy storage device may be used as a wearable device. The wearable device generally refers to a device that can be worn on a human body, such as glasses, a watch, clothes, or the like, and the energy storage device may be used as an energy storage of the wearable device. That is, as described above in the first and second aspects of the present application, the energy storage device may be stably bent since a flexible electrode substrate of a form in which a flexible substrate is impregnated in the pores of a patterned porous electrode is included as an electrode. Therefore, the energy storage device does not generate a problem such as a crack even after bending, and since the electrochemical properties are maintained, excellent electrochemical properties can be maintained even when it is applied to a wearable device, and since it has an adhesive property, it can be easily attached to an object and may be effectively applied to a wearable device.

In a third aspect of the present application,

there is provided a method of manufacturing a flexible electrode substrate, the method comprising the steps of: forming a patterned porous electrode on the surface of a temporary substrate; attaching a flexible substrate to the temporary substrate on which the patterned porous electrode is formed, and impregnating the flexible substrate in the pores of the porous electrode; and separating the flexible substrate impregnated in the pores of the porous electrode from the temporary substrate, and moving the patterned porous electrode to the flexible substrate.

Although detailed descriptions of the parts overlapping with the first and second aspects of the present application are omitted, the descriptions of the first and second aspects of the present application may be equally applied although the descriptions are omitted in the third aspect.

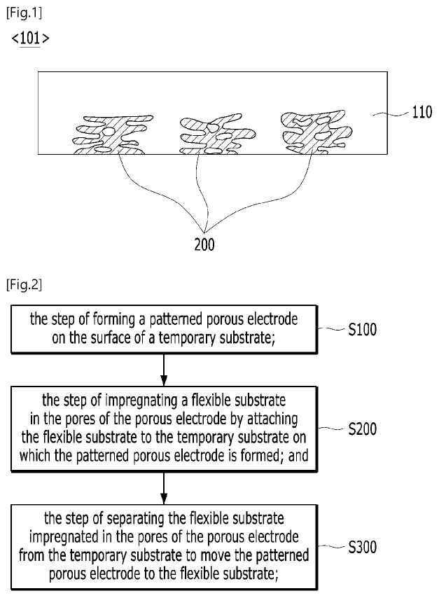

Hereinafter, a method of manufacturing a flexible electrode substrate according to a third aspect of the present application will be described in detail step by step with reference to FIG. 2.

First, in one embodiment of the present application, the method of manufacturing a flexible electrode substrate includes the step of forming a patterned porous electrode on the surface of a temporary substrate (S100).

In one embodiment of the present application, the step of forming a patterned porous electrode on the surface of a temporary substrate may be performed using laser irradiation, deposition, or exposure. At this point, although there is no particular restrictions on the type of the temporary substrate, it is preferable to use a substrate without having adhesive properties. For example, although the temporary substrate may be a SiO₂/Si wafer, it is not limited thereto. In addition, the average pore diameter of the patterned porous electrode may be 0.001 to 50 μm, preferably 0.01 to 20 μm, and when the average pore diameter of the porous electrode is smaller than 0.001 μm, the flexible substrate may not be impregnated in the pores of the porous electrode at the step described below, and when the average pore diameter of the porous electrode is larger than 50 μm, performance as an electrode may be lowered as porosity of the pores is relatively too high and the volume of the electrode itself is too small. The average pore diameter of the porous electrode 200 may be adjusted and applied according to the type and size of an applied device, and for example, when it is applied to the electrode of a micro-supercapacitor, the porous electrode 200 may further preferably have an average pore diameter of 0.01 to 10 μm.

On the other hand, the material of the porous electrode may be a carbon material, and the carbon material may include a material selected from a group configured of reduced graphene oxide (rGO), activated carbon, activated carbon fiber, carbon nanotube (CNT), and combinations thereof. On the other hand, the material of the porous electrode is not limited only to the carbon material, and additionally, a composite material of a metal oxide and the carbon material, a composite material of a two-dimensional material and the carbon material, or the like may be used. At this point, the metal oxide may include a material selected from a group configured of, for example, MnO₂, Mn₂O₃, Mn₃O₄, RuO₂, CoO, Co₂O₃, Co₃O₄, WO₃, SnO₂, NiO, IrO₂, RuO₂, V₂O₅, MoO₃, and combinations thereof, and the two-dimensional material may include a material selected from a group configured of, for example, MoS₂, MoSe₂, MoTe₂, TiS₂, TiSe₂, TiTe₂, WS₂, WSe₂, WTe₂, and combinations thereof.

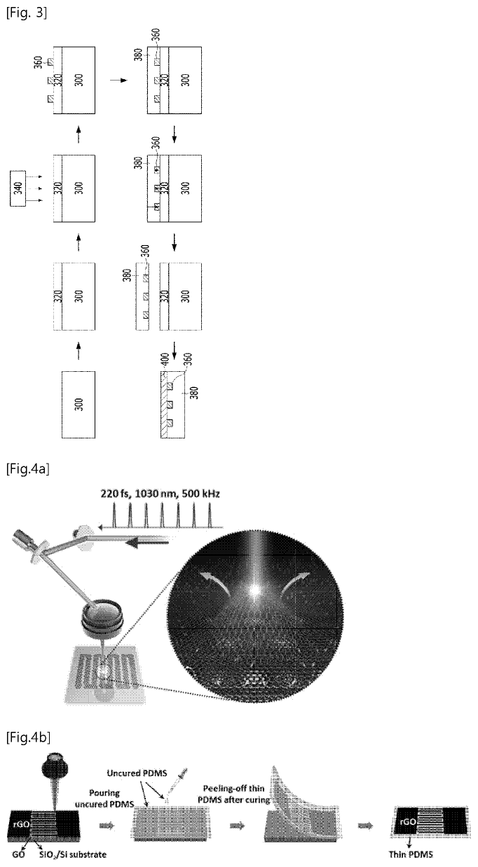

In one embodiment of the present application, the step of forming a patterned porous electrode on the surface of a temporary substrate may be preferably performed using laser irradiation. An embodiment thereof is shown in FIG. 3, and referring to FIG. 3, when laser irradiation is used, the method of manufacturing a flexible electrode substrate may include the steps of: coating a precursor 320 of the porous electrode on the surface of the temporary substrate 300; forming a patterned porous electrode 360 on a portion irradiated with the laser by radiating the laser on a portion of the surface of the temporary substrate 300 coated with the precursor 320 of the porous electrode using a laser irradiation device 340; impregnating a flexible substrate 380 in the pores of the porous electrode 360 by attaching the flexible substrate 380 to the temporary substrate 300 on which the patterned porous electrode 360 is formed; and separating the flexible substrate 380 impregnated in the pores of the porous electrode 360 from the temporary substrate 300, and moving the patterned porous electrode 360 to the flexible substrate 380. However, the manufacturing method is only a preferred embodiment, and in the present invention, the method of manufacturing a flexible electrode substrate is not limited to the above manufacturing method. Meanwhile, although FIG. 3 does not specifically show the shape of the flexible substrate 380 impregnated in the pores of the porous electrode 360 for convenience, the impregnated shape may follow the structure of FIG. 1.

According to the manufacturing method, the ratio of the thickness of the porous electrode 360 to the thickness of the precursor 320 of the porous electrode may be 1:1 to 10. Meanwhile, the radiated laser may be a femtosecond laser, and the laser may have a laser pulse width of 100 to 500 fs. In addition, intensity of the radiated laser may be 100 to 500 mW, and the laser repetition rate may be 100 to 1,000 kHz, and the scanning rate may be 10 to 500 mm/s. On the other hand, the method of manufacturing a flexible electrode substrate using laser irradiation may further includes, after the step of separating the flexible substrate 380 impregnated in the pores of the porous electrode 360 from the temporary substrate 300 and moving the patterned porous electrode 360 to the flexible substrate 380, the step of coating the coating layer 400 on the other surface of the flexible substrate 380 on which the patterned porous electrode 360 is formed. This will be described below in more detail.

In one embodiment of the present application, using the deposition may be performed by depositing a porous electrode on the surface of the temporary substrate, and at this point, the deposition may be performed using a chemical vapor deposition method, a physical vapor deposition method, or an atomic layer deposition method.

In one embodiment of the present application, using the exposure may be performed by exposing the surface of the temporary substrate and etching the surface. At this point, the exposure may be performed using nanoimprint lithography, electron beam lithography, or extreme ultraviolet lithography, and the etching may be dry etching or wet etching.

Next, in one embodiment of the present application, the method of manufacturing a flexible electrode substrate includes the step of attaching the flexible substrate to the temporary substrate on which the patterned porous electrode is formed, and impregnating the flexible substrate in the pores of the porous electrode (S200).

In one embodiment of the present application, the flexible substrate may include a compound that is expressed by the chemical formula 1 shown below.

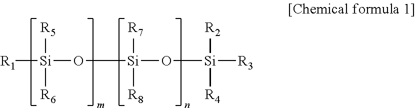

In the chemical formula 1,

R1 to R8 are each independently hydrogen, halogen, hydroxyl group, amino group, straight or branched C1-C10 alkyl, straight or branched C1-C10 alkoxy, straight or branched C1-C10 amino alkyl, straight or branched C2-C10 alkenyl, C3-C20 cycloalkyl, C6-C30 aryl, or C1-C20 alkylcarbonyl, and m and n are each independently an integer between 0 and 100.

In one embodiment of the present application, although the material expressed by chemical formula 1 may include a repeating unit of Si—O, and preferably may be polydimethyl siloxane (PDMS), Ecoflex, or a mixture of them, it is not limited thereto, and any material having adhesive properties may be used as the flexible substrate.

In one embodiment of the present application, the step of impregnating the flexible substrate in the pores of the porous electrode may include the steps of applying a flexible substrate precursor on the temporary substrate on which the patterned porous electrode is formed, and curing the applied flexible substrate precursor. Meanwhile, in another embodiment, attachment of the flexible substrate may be attaching the flexible substrate using a semi-cured flexible substrate, and at this point, attachment of the semi-cured flexible substrate may be performed under a predetermined pressure, and the predetermined pressure may be about 70 to 300 N/m². That is, step S200 may be performed by applying the precursor of the flexible substrate to the temporary substrate on which the porous electrode is formed, and then impregnating the precursor of the flexible substrate into the pores of the porous electrode, and curing the precursor, and as another method, it may be performed by attaching the semi-cured flexible substrate to the substrate, on which the porous electrode is formed, under a predetermined pressure, and impregnating the semi-cured flexible substrate into the pores of the porous electrode.

Next, in one embodiment of the present application, the method of manufacturing a flexible electrode substrate includes the step of separating the flexible substrate impregnated in the pores of the porous electrode from the temporary substrate, and moving the patterned porous electrode to the flexible substrate (S300).

In one embodiment of the present application, only the porous electrode patterned through the step S300 may be moved to the flexible substrate, and this may be due to the adhesive properties of the flexible substrate itself and the morphological characteristics of the flexible substrate impregnated in the pores of the porous electrode. That is, as a flexible electrode substrate including a flexible substrate and a patterned porous electrode formed on one surface of the flexible substrate, a flexible electrode substrate of a form in which the flexible substrate is impregnated in the pores of the patterned porous electrode may be obtained through step S300. The obtained flexible electrode substrate may be used as a positive electrode and/or a negative electrode of an energy storage device, and the energy storage device may be preferably a supercapacitor, further preferably a pseudocapacitor or a micro-supercapacitor. In addition, since the energy storage device includes a flexible substrate having an adhesive property as an electrode, it may be freely attached to and detached from a desired object.

Next, in one embodiment of the present application, the method of manufacturing a flexible electrode substrate may further include, after step S300, the step of forming a coating layer on the other surface of the flexible substrate to which the patterned porous electrode has been moved.

In one embodiment of the present application, the coating layer may include a material having a functional group selected from a group configured of a catechol group, a galloyl group, a hydroquinone group, an amine group, and combinations thereof, and preferably, the coating layer may include dopamine or tannic acid. The flexible electrode substrate may have a characteristic of generating redox more smoothly due to the coating layer formed on the other surface, and therefore, the energy storage device including the flexible electrode substrate as an electrode may have excellent electrochemical properties.

In one embodiment of the present application, there may be a plurality of coating layers formed on the other surface of the flexible electrode substrate, and for example, when there are two coating layers, the flexible electrode substrate may have a first coating layer formed on the other surface, and a second coating layer formed on the first coating layer. At this point, the first coating layer and the second coating layer may include a functional group selected from a group configured of a catechol group, a galloyl group, a hydroquinone group, and combinations thereof on each of the surfaces, and the first coating layer and the second coating layer may be connected to each other by the ions that have coordinate bonds with the each of the functional groups. Meanwhile, preferably, the ions may be Fe ions, but are not limited thereto, and all ions capable of coordinating with the functional groups may be used. In addition, when there are three or more coating layers, each coating layer may be deposited in the same manner as described above, and this is implemented in a layer-by-layer (LDL) deposition method using strong interactions between the functional groups and the ions.

### DESCRIPTION OF SYMBOLS

101: Flexible electrode substrate

110: Flexible substrate

200: Porous electrode

300: Temporary substrate

320: Precursor of porous electrode

340: Laser radiation device

360: Porous electrode

380: Flexible substrate

400: Coating layer

### INDUSTRIAL APPLICABILITY

According to an embodiment of the present invention, the flexible electrode substrate is very useful since it can be attached to various objects as it has excellent electrochemical properties and adhesive properties. Particularly, since the flexible electrode substrate can be used as an electrode of an energy storage device, the energy storage device including the flexible electrode substrate can be attached to various objects, and therefore, it can be used as a sticker-type energy storage device.

In addition, the manufacturing process of the flexible electrode substrate is simple since it can be easily manufactured in a transfer method using a difference in adhesive strength, and it is very efficient since electrodes having various patterns can be manufactured through easy control of the manufacturing process.

It should be understood that the effects of the present invention are not limited to the effects described above, and include all effects that can be inferred from the configuration of the present invention described in the detailed description or claims of the present invention.

1. A flexible electrode substrate comprising:
a flexible substrate; and
a patterned porous electrode formed on one surface of the flexible substrate, wherein
the flexible substrate is impregnated in pores of the patterned porous electrode.

2. The flexible electrode substrate according to claim 1, wherein the flexible substrate includes a compound that is expressed by chemical formula 1 shown below. 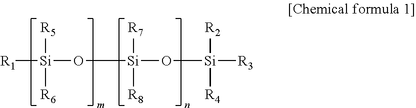
(In the chemical formula 1, R1 to R8 are each independently hydrogen, halogen, hydroxyl group, amino group, straight or branched C1-C10 alkyl, straight or branched C1-C10 alkoxy, straight or branched C1-C10 amino alkyl, straight or branched C2-C10 alkenyl, C3-C20 cycloalkyl, C6-C30 aryl, or C1-C20 alkylcarbonyl, and m and n are each independently an integer between 0 and 100.)

3. The flexible electrode substrate according to claim 1, wherein an average pore diameter of the porous electrode is 0.001 to 50 μm.

4. The flexible electrode substrate according to claim 3, wherein the porous electrode includes a porous carbon material.

5. The flexible electrode substrate according to claim 4, wherein the porous carbon material includes a material selected from a group configured of reduced graphene oxide (rGO), activated carbon, activated carbon fiber, carbon nanotube (CNT), and combinations thereof.

6. The flexible electrode substrate according to claim 1, further comprising a coating layer formed on the other surface.

7. The flexible electrode substrate according to claim 6, wherein the coating layer includes a material having a functional group selected from a group configured of a catechol group, a galloyl group, a hydroquinone group, an amine group, and combinations thereof.

8. An energy storage device comprising the flexible electrode substrate of claim 1 as a positive electrode or a negative electrode.

9. The device according to claim 8, wherein the energy storage device is a supercapacitor, a secondary battery, or a redox battery.

10. The device according to claim 8, wherein a width of the porous electrode is 0.05 to 2 mm.

11. The device according to claim 8, wherein a distance between the electrodes of the patterned porous electrode is 0.01 to 1 mm.

12. The device according to claim 8, wherein the positive electrode and the negative electrode are disposed to face each other, and the energy storage device further includes an electrolyte formed between the positive electrode and the negative electrode.

13. The device according to claim 12, wherein the electrolyte includes a material selected from a group configured of a solid electrolyte, an aqueous electrolyte, an organic electrolyte, and combinations thereof.

14. A wearable device comprising the energy storage device of claim 8.

15. A method of manufacturing a flexible electrode substrate, the method comprising the steps of:
forming a patterned porous electrode on the surface of a temporary substrate;
attaching a flexible substrate to the temporary substrate on which the patterned porous electrode is formed, and impregnating the flexible substrate in the pores of the porous electrode; and
separating the flexible substrate impregnated in the pores of the porous electrode from the temporary substrate, and moving the patterned porous electrode to the flexible substrate.

16. The method according to claim 15, wherein the step of forming a patterned porous electrode on the surface of a temporary substrate is performed using laser irradiation, deposition, or exposure.

17. The method according to claim 16, wherein using laser irradiation includes the steps of:
coating a precursor of the porous electrode on the surface of the temporary substrate; and
forming a patterned porous electrode on a portion irradiated with a laser by radiating the laser on a portion of the surface of the temporary substrate coated with the precursor of the porous electrode.

18. The method according to claim 17, wherein a ratio of a thickness of the porous electrode to a thickness of the precursor of the porous electrode is 1:1 to 10.

19. The method according to claim 15, wherein the step of impregnating the flexible substrate in the pores of the porous electrode includes the steps of:
applying a flexible substrate precursor on the temporary substrate on which the patterned porous electrode is formed; and
curing the applied flexible substrate precursor.

20. The method according to claim 15, wherein attachment of the flexible substrate is attaching the flexible substrate using a semi-cured flexible substrate.
